(19) United States
(12) Patent Application Publication
(10) Pub. No.: US 2011/0197635 A1
(43) Pub. Date: Aug. 18, 2011

(54) Optimized Scoop for Improved Gob Shape

(76) Inventors: Braden A. McDermott, West Hartford, CT (US); Jonathan S. Simon, Pleasant Valley, CT (US); Xu Ding, West Hartford, CT (US)

(21) Appl. No.: 12/705,295

(22) Filed: Feb. 12, 2010

(51) Int. Cl. C03B 17/00; C03B 7/14

(52) U.S. Cl. 65/127; 65/304

(57) ABSTRACT

An optimized scoop for receiving the glass gobs formed by the shearing mechanism is disclosed which provides an optimal trajectory that enables glass gobs passing therethrough to have an improved glass gob shape together with a negligible increase in glass gob length, with a velocity that is equal to or better than that of previously known scoops. The optimized scoop enhances glass gob shape to produce a more uniformly cylindrical glass gobs and eliminate dog-bone configurations. Trajectory of the optimized scoop is optimized both to enhance exit velocity of the glass gobs and minimize forces applied to the glass gobs.

### BACKGROUND OF THE INVENTION

### Field of the Invention

The present invention relates generally to apparatus for delivering molten gobs of glass supplied by a shearing mechanism from a stream of molten glass to the parison molds of an Individual Section (IS) machine for making glass containers, and more particularly to a scoop for receiving the glass gobs formed by the shearing mechanism and providing an optimal trajectory while ensuring that glass gobs passing therethrough will have an optimal and uniform gob shape.

Glass containers are made in a manufacturing process that has three distinct operations, namely the batch house, the hot end, and the cold end. The batch house is where the raw materials for glass (which are typically sand, soda ash, limestone, feldspar, cullet (crushed, recycled glass), and other raw materials) are prepared and mixed into batches. The hot end melts the batched materials into molten glass, distributes discrete segments of molten glass referred to in the industry as glass “gobs” to molding apparatus where they are molded into glass containers, and anneals the glass containers to prevent them from being weakened due to stresses caused by uneven cooling. The cold end inspects the glass containers to ensure that they are of acceptable quality.

Typically, the molding portion of the hot end of the manufacturing process is performed in an Individual Section or IS forming machine, which contains between five and twenty identical sections, each of which is capable of making one, two, three, or four containers simultaneously. The hot end begins with a furnace, in which the batched materials are melted into molten glass, and from which streams of molten glass flow through a feeder bowl to multiple outlets. Since each section of an IS machine has one, two, three, or four sets of molding apparatus which will operate simultaneously, one, two, three, or four outlets from the furnace will simultaneously supply streams of molten glass to these respective sets of molding apparatus. Each of the streams of molten glass is cut with a shearing mechanism into uniform segments of glass called gobs, which fall by gravity and are guided through scoops, troughs, and deflectors into their respective blank (or parison) molds in the section of the IS machine.

In each set of blank molds, a pre-container referred to as a parison is formed, either by using a metal plunger to push the glass gob into the blank mold, or by blowing the glass gob out from below into the blank mold. The parison is then inverted and it is transferred to a second or blow mold, where the parison is blown out into the shape of the finished glass container. The blown parison is then cooled in the blow mold to the point where it is sufficiently rigid to be gripped and removed from the blow station.

The general focus of the present invention is on the apparatus that distributes a glass gob to the molding apparatus in a section, which apparatus typically includes a scoop, a trough, and a deflector. Such an apparatus is taught, for example, in U.S. Pat. No. 5,549,727, to Meyer, which patent is assigned to the assignee of the present patent application and is hereby incorporated herein by reference in its entirety. The scoop receives a vertically falling glass gob at a location under the shearing mechanism and is curved to redirect the trajectory of the glass gob from a vertical drop at a first or inlet end of the scoop to an angular trajectory at a second or outlet end of the scoop.

From the second or outlet end of the scoop, the glass gob enters a first or upper end of an upwardly facing downwardly sloping generally straight trough that is generally aligned with the second or outlet end of the scoop and exits a second or lower end of the trough. In some cases, the upper end of the scoop is wider than glass gobs entering the scoop to ensure that the glass gobs will be captured within the scoop. From the second or lower end of the trough, the glass gob enters the upper end of a downwardly facing curved deflector and is redirected to a vertical drop at a second or lower end of the deflector, from which the glass gob is directed into the blank mold. The upper end of the deflector is generally aligned with the second or outlet end of the trough. The trough has a generally U-shaped cross-sectional configuration that is open on its upwardly facing side, while the deflector has a generally inverted U-shaped cross-sectional configuration that is open in its downwardly facing side.

The specific focus of the present invention is on first element of this glass gob distributing apparatus, the scoop. It will be appreciated by those skilled in the art that delivering a good glass gob to the blank mold is of great importance and that the design of the scoop has a direct impact on the shape of the glass gob as it transits the scoop. A good glass gob should have a uniform shape and should be the correct length for the blank mold. Further, in order to get the glass gob to load deep into the blank mold, a high gob velocity is required as well as a properly shaped glass gob. It is not possible to make a good glass container from a poor quality or slow glass gob.

A glass gob is formed from molten glass dropping from an orifice in a gob feeder in a glass stream. This glass stream falls downwardly due to the forces of gravity, and is cut into uniform glass gobs by a shear mechanism. Since the molten glass flowing downwardly from the orifice 26 in the gob feeder is very fluid, as the glass stream drops through gravity, it begins to break away in the middle, below the point at which the glass gob is cut by the shear mechanism. The shape of the glass gob is also influenced by an oscillating motion of a “needle” located in the gob feeder that tends to push molten glass out of the orifice in the gob feeder as it moves downward and tends to draw the glass back up into the orifice as it moves upward. This produces a glass gob having enlarged upper and lower portions with a narrowed intermediate portion, a shape which is referred to in the industry as a “dog-bone” shape.

During the time that the glass gob is deposited into the scoop and transits the scoop, the trough, and the deflector and drops into the blank mold, it has been determined that the glass gobs do not recover from variations in the shape of the glass gobs as they are supplied to this delivery system. While popular belief in the past has been that they can recover their shape in this delivery system to some degree, the inventors have determined that this is not the case. However, the inventors have determined that any shaping of glass gobs that is done in this delivery system will affect the shape of the glass gobs delivered to the blank mold.

However, in the past no shaping of glass gobs in this delivery system has been successfully attempted due to the fact that any such shaping has resulted in a significant adverse effect on the speed of the glass gobs, namely slowing of the speed of the glass gobs in the glass gob delivery system. In order to ensure that the glass gobs load deeply within the blank mold, it is necessary to ensure that the glass gobs have a high gob velocity. Any loss in the speed of the glass gobs as they are delivered to blank molds will have an adverse effect on parison quality, and thus on finished glass container quality when such imperfect parisons are blown, which represents a serious adverse consequence.

Thus, it is apparent that it would be desirable to improve glass gob shape as the glass gobs transit the scoop. However, such improvements in glass gob shape would have to be accomplished in the scoop without a significant decrease in the speed of the glass gobs in the glass gob delivery system. Such improvements in glass gob shape in the scoop should thus enhance glass gob shape to produce a more uniformly cylindrical glass gobs, thereby eliminating the dog-bone shape (as well as any other non-uniform gob shapes), so long as that is accomplished while maintaining a sufficient glass gob exit velocity from the scoop. Further, it is also desirable that the improvement in glass gob shape be accomplished in the scoop without significantly lengthening the glass gobs.

The optimized scoop of the present invention must also be of construction which is both durable and long lasting, and it should also require little or no maintenance to be provided by the user throughout its operating lifetime. In order to enhance the market appeal of the optimized scoop of the present invention, it should also be of inexpensive construction to thereby afford it the broadest possible market. Finally, it is also an objective that all of the aforesaid advantages of the optimized scoop of the present invention be achieved without incurring any substantial relative disadvantage.

### SUMMARY OF THE INVENTION

The disadvantages and limitations of the background art discussed above are overcome by the present invention. With this invention, two fundamental changes are made to the configuration of a scoop to optimize the scoop to transit glass gobs therethrough while giving the glass gobs an optimized shape without substantially sacrificing glass gob velocity. The first change is to provide a gradual taper to the optimized scoop to facilitate shaping of the glass gob into a more cylindrical configuration as it transits the optimized scoop. The second change is to provide an optimum glass gob trajectory within the optimized scoop to increase the velocity of the glass gob as it transits the optimized scoop.

Thus, the focus of the new optimized scoop is to provide glass gobs having an optimal shape without sacrificing glass gob velocity. An optimal trajectory for the optimized scoop is selected to increase the glass gob speed over that of existing scoops, while elongating the glass gob only slightly. The cross-sectional configuration of the optimized scoop is gradually tapered and has a lower end that is slightly smaller than the largest diameter portion of glass gobs delivered to the optimized scoop. While existing scoops have utilized a flared opening at the upper end to provide a funneling effect to help ensure that glass gobs are captured by the scoop, they have not been tapered in the manner utilized by the optimized scoop of the present invention, which is tapered to cause the glass gob to be slightly extruded, thus obtaining a desirable shape. This helps the optimized scoop to shape glass gobs into a more cylindrical shape, and the optimized scoop will then guide the glass gobs into the correct landing zone in the trough. (Variations in the landing of glass gobs in the trough eventually result in glass container defects due to oddly shaped glass gobs.)

It has been determined by the inventors that by forcing glass gobs through a reduced cross-section achieved by a tapering of the cross-sectional configuration of the optimized scoop from the upper end to the lower end, they may be extruded to a highly repeatable length, so long as the weight and viscosity of the glass gobs remain constant. The other benefit of such a configuration is that the glass gobs can not “wander” down the optimized scoop (from high speed video it has been determined that, in some cases, glass gobs actually slaloms down the scoop).

This cross-section design of the optimized scoop can greatly reduce the variations in glass gobs due to non-uniform glass gobs being provided from the gob feeder to the scoop or due to transit (wandering) of the glass gobs as they pass through previously known scoop designs. With the improved cross-sectional configuration of the optimized scoop, it is possible to simultaneously improve glass gob shape and reduce variations in the glass gobs delivered to the trough, while reducing glass gob speed only marginally. Another effect of the optimized scoop is the elimination of dog-bone configurations of the glass gobs.

While it will be appreciated that the reduced cross-sectional configuration of the optimized scoop will marginally reduce the velocity of glass gobs transiting the optimized scoop, the optimized scoop of the present invention is able to minimize this velocity reduction and may actually marginally increase the velocity of glass gobs (relative to previously known scoop designs) transiting the optimized scoop by utilizing a unique scoop trajectory design. Unlike previously known scoops that use a curvature having a selected radius, the optimized scoop of the present invention uses Bezier curves to define the trajectory of the optimized scoop. (Bezier curves are well known, and are curved lines that are defined by mathematical equations.)

Bezier parameterization produces generally well behaved optimized scoop profiles that successfully avoid discontinuities and reversals in curvature. The use of Bezier curves also allows for the creation of unique optimized scoop profiles very quickly. The optimized scoop of the present invention preferably has a trajectories that is continuous, monotonically decreasing (no local minima), and has no sign changes in curvature, which requirements are all fulfilled by Bezier parameterization using control points. By modifying the control points of Bezier curves, different configurations of scoops can be created and modeled in order to optimize the scoop. Additionally, by performing a normal force load analysis on the scoop design to maintain smooth increases and decreases in the normal force applied to glass gobs in the scoop that are caused by the curvature, the impact of such normal forces on glass sobs may also be minimized.

It may therefore be seen that the present invention teaches an optimized scoop that improves glass gob shape as the glass gobs transit the optimized scoop. The improvements in glass gob shape are accomplished in the optimized scoop without any significant decrease in the speed of the glass gobs as they transit the glass gob delivery system. The improvements in glass gob shape in the optimized scoop thus enhance glass gob shape to produce a more uniformly cylindrical glass gobs and eliminate the dog-bone shape, while the optimized trajectory of the optimized scoop prevents any significant reduction in the speed of the glass gobs such that they maintain a sufficient exit velocity from the optimized scoop. Further, the improvement in glass gob shape is accomplished in the optimized scoop without significantly lengthening the glass gobs.

The optimized scoop of the present invention is of a construction which is both durable and long lasting, and which will require little or no maintenance to be provided by the user throughout its operating lifetime. The optimized scoop of the present invention is also of inexpensive construction to enhance its market appeal and to thereby afford it the broadest possible market. Finally, all of the aforesaid advantages and objectives of the optimized scoop of the present invention are achieved without incurring any substantial relative disadvantage.

### DESCRIPTION OF THE DRAWINGS

These and other advantages of the present invention are best understood with reference to the drawings, in which:

FIG. 1 is a side view of a generic glass gob delivery system for supplying a glass gob to a parison mold, showing a scoop, a trough, and a deflector;

FIG. 2 is a side view showing the configuration of a glass gob supplied by the scoop of a conventional glass gob delivery system;

FIG. 3 is an isometric view of an optimized scoop of the present invention from above and one side of the optimized scoop showing the taper from the top end to the bottom end thereof;

FIG. 4 is a plan view of the upper end of the optimized scoop illustrated in FIG. 3, showing the cross-sectional configuration of the optimized scoop at the upper end thereof;

FIG. 5 is a plan view of the lower end of the optimized scoop illustrated in FIGS. 3 and 4, showing the cross-sectional configuration of the optimized scoop at the lower end thereof;

FIG. 6 is a cross-sectional view of the optimized scoop illustrated in FIGS. 3 and 4, showing the scoop trajectory that is defined by an optimized Bezier curve;

FIG. 7 is an exploded bottom plan view showing the fluid cooling passageway located within the optimized scoop illustrated in FIG. 3 prior to the covers being welded to enclose the fluid cooling passageway;

FIG. 8 is an exemplary Bezier curve showing the four control points that define a Bezier curve;

FIG. 9 is a Bezier curve family for optimization of the scoop trajectory of the optimized scoop illustrated in 3 through 7;

FIG. 10 is a series of plots showing the normal force applied to a glass gob passing through the optimized scoop illustrated in 3 through 5 for several different initial velocities as the glass gob enters the optimized scoop; and

FIG. 11 is a side view showing the configuration of a glass gob supplied by the optimized scoop of the present invention.

### DETAILED DESCRIPTION OF THE EXEMPLARY EMBODIMENT

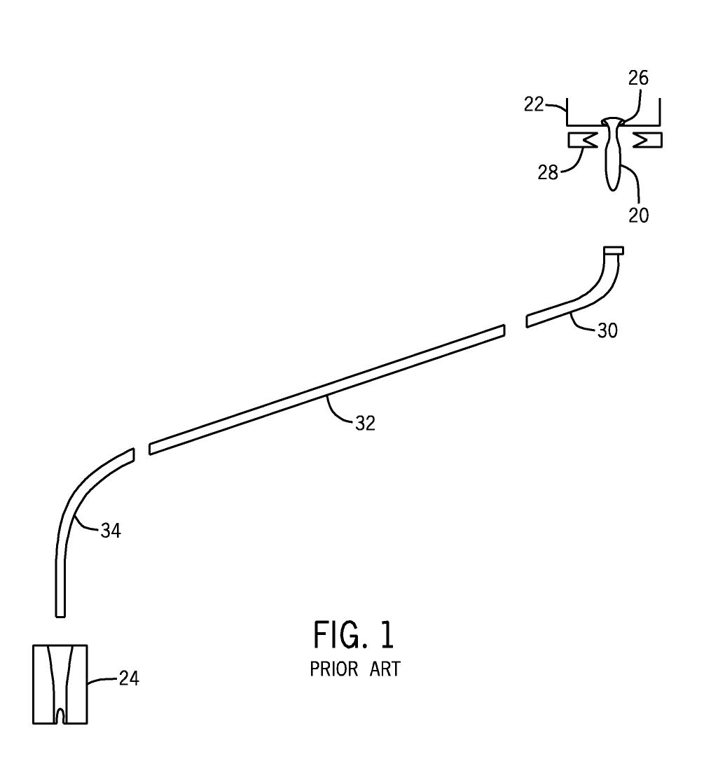

Prior to discussing the exemplary embodiment of the present invention, it is helpful to briefly describe the location and function of a scoop in a generic glass gob delivery system used to supply glass gobs to an I.S. machine. Referring to FIG. 1, such a glass gob delivery system is illustrated in schematic form depicting the gravitational delivery of a glass gob 20 from a gob feeder 22 to a parison mold 24. Molten glass exits the gob feeder 22 through an orifice 26 in the bottom of the gob feeder 22, and is cut by a schematically depicted glass gob shear mechanism 28 into a sequence of glass gobs 20.

The glass gobs 20 fall downwardly into the top end of a scoop 30 that is curved to redirect the glass gobs 20 from a vertical trajectory to a diagonal trajectory, and from the bottom end of the scoop 30 into the upper end of an inclined trough 32. From the lower end of the trough 32, the glass gobs 20 are directed into the top end of a deflector 34 that is curved to redirect the glass gobs 20 from the diagonal trajectory back to a vertical trajectory above the parison mold 24. From the lower end of the deflector 34, the glass gobs 20 fall into the open top side of the parison mold 24.

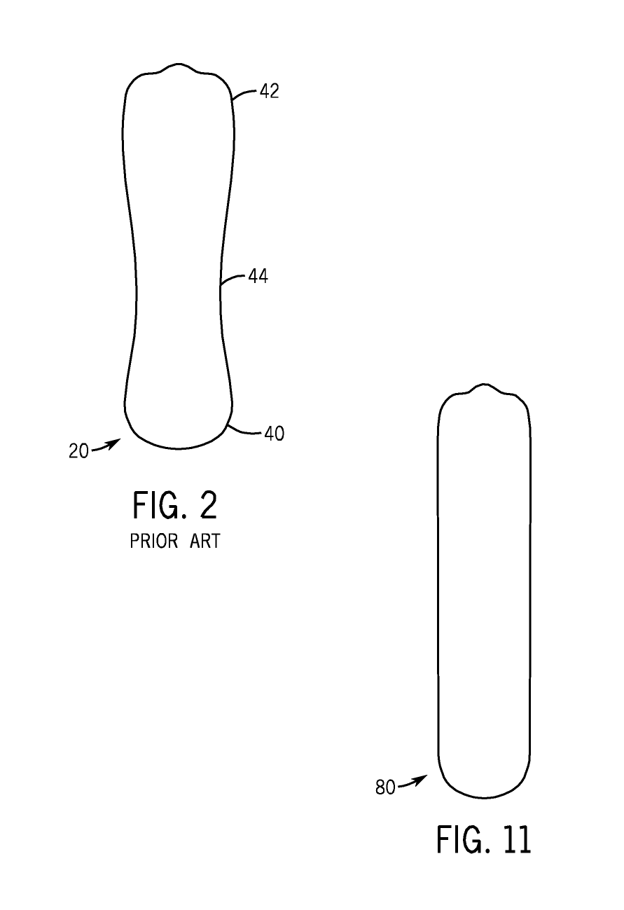

Referring next to FIG. 2, a glass gob 20 supplied from the scoop 30 of a conventional glass gob delivery system is shown. It may be seen that the glass gob 20 has an enlarged lower portion 40 as well as an enlarged upper portion 42, with a narrowed intermediate portion 44 located therebetween (the degree of the narrowing at the narrowed intermediate portion 44 of the glass gob 20 has been somewhat exaggerated for purposes of clarity). Since the molten glass flowing out of the orifice 26 in the gob feeder 22 (shown in FIG. 1) is very fluid, as the glass gob 20 (as shown in FIG. 1) drops through gravity, it begins to break away in the middle, producing the shape shown in FIG. 1, which is referred to in the industry as a “dog-bone” shape. This dog-bone shape, which is present at the glass gob shear mechanism, is maintained by glass gobs 20 as they go through a conventional glass gob delivery system, and is one cause of improper gob loading in the parison mold 24 (shown in FIG. 1).

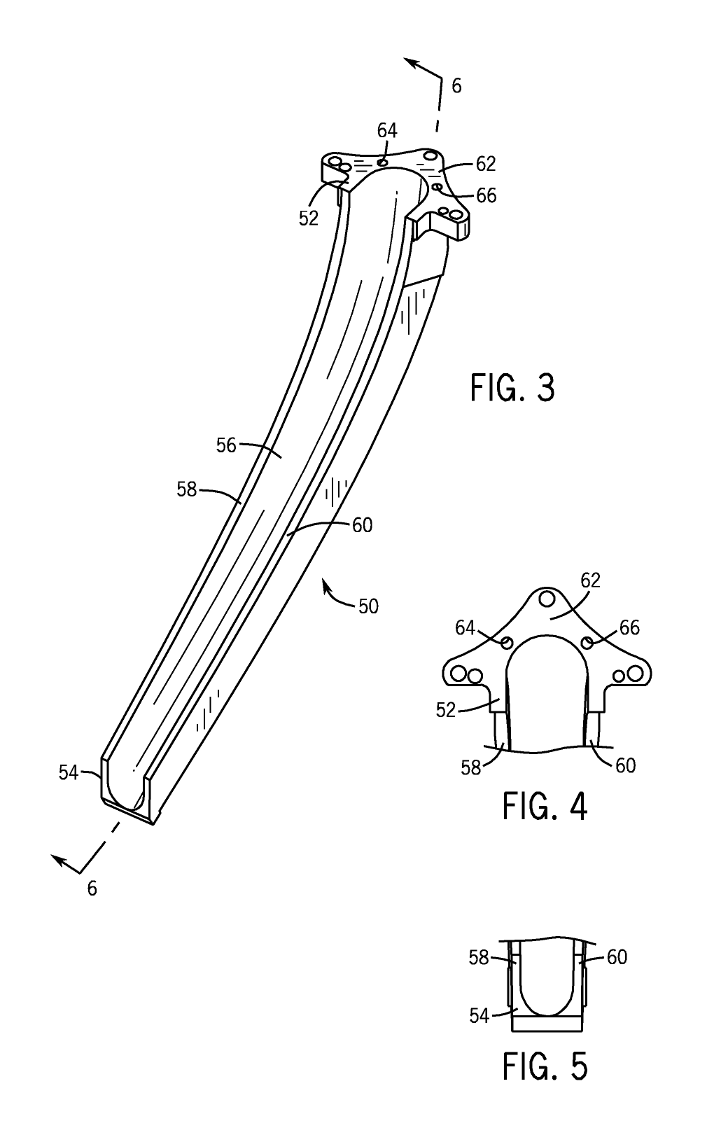

Referring now to FIGS. 3 through 7, an optimized scoop 50 that is constructed according to the teachings of the present invention is shown. The scoop has an upper end 52 and a lower end 54 with a smooth curved portion 56 extending therebetween. The optimized scoop 50 will be mounted so that the upper end 52 of the optimized scoop 50 will act as an inlet to the optimized scoop 50, receiving glass gobs (not shown in FIGS. 3 through 7) which will fall through the force of gravity vertically into the upper end 52 of the optimized scoop 50. The curved portion 56 of the optimized scoop 50 will modify the trajectory of the glass gobs such that they will exit the optimized scoop 50 at the lower end 54 of the optimized scoop 50 at an acute angle with respect to the horizontal that delivers the glass gobs to the trough 32 (shown in FIG. 1) with the proper trajectory (which, by way of example, may be approximately thirty degrees, but may vary as desired to accommodate any glass gob delivery system).

The cross-sectional configuration of the optimized scoop 50 is generally concave (in a two-dimensional sense) and preferably U-shaped, with the bottom of the U-shape preferably being semicircular and the opposite sides 58 and 60 of the optimized scoop 50 above the semicircle preferably being essentially parallel along the curved portion 56 of the optimized scoop 50. It should be noted that these characteristics may vary somewhat without departing from the teachings of the present invention (and thus could potentially include a more V-shaped configuration as well). The width of the semicircular bottom of the U-shape preferably varies along the curved portion 56 of the optimized scoop 50 from a maximum width at the upper end 52 of the optimized scoop 50 to a minimum width at the lower end 54 of the optimized scoop 50 to thereby produce a tapered width along the length of the curved portion 56 of the optimized scoop 50.

The optimized scoop 50 has a mounting flange 62 located at the upper end 52 of the optimized scoop 50, with this mounting flange 62 being used to support the optimized scoop 50 in position in a glass gob delivery system. Located in the mounting flange 62 are a cooling fluid inlet 64 and a cooling fluid outlet 66, which will be used to couple a cooling fluid into and out of the optimized scoop 50. It should be noted that 64 and 66 could also be reversed if so desired.

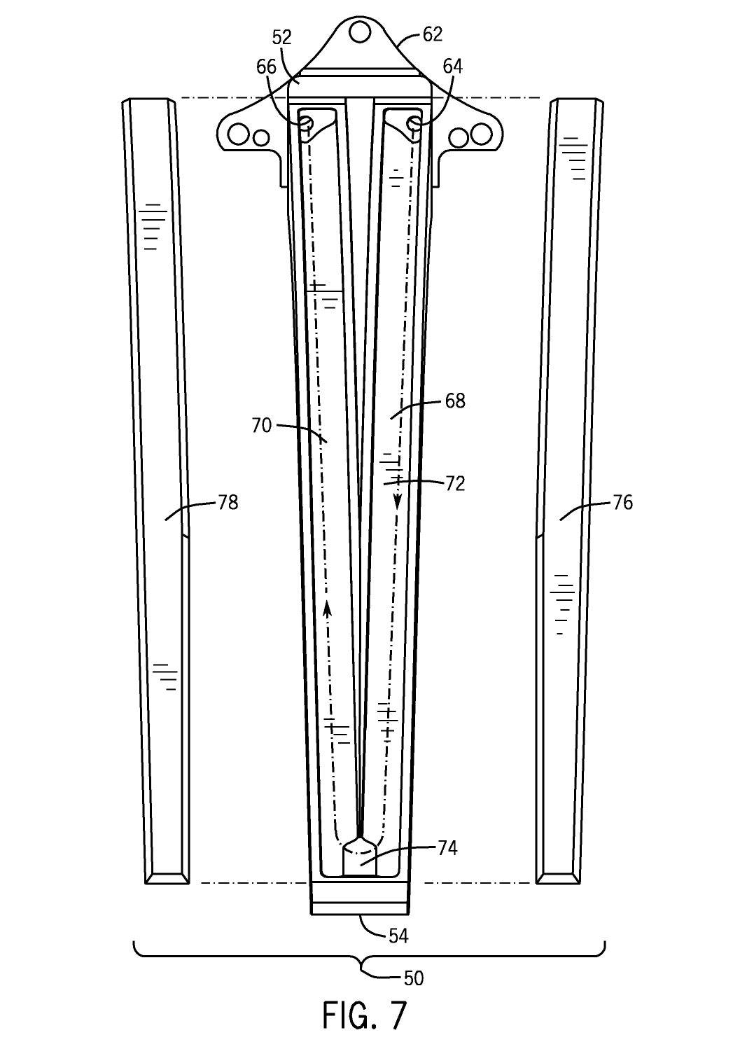

Located within the optimized scoop 50 and visibly from the underside thereof (best shown in FIG. 7) are two parallel cooling channels 68 and 70 which extend nearly the entire length of the optimized scoop 50. The end of the cooling channel 68 near the upper end 52 of the optimized scoop 50 is in fluid communication with the cooling fluid inlet 64, and the end of the cooling channel 70 near the upper end 52 of the optimized scoop 50 is in fluid communication with the cooling fluid outlet 66. The cooling channels 68 and 70 are separated by a V-shaped rib 72. The cooling channels 68 and 70 are connected together by a channel 74 located near the lower end 54 of the optimized scoop 50.

A curved panel 76 is placed over the cooling channel 68 and welded in place on the optimized scoop to enclose the cooling channel 68. Likewise, a curved panel 78 is placed over the cooling channel 70 and welded in place on the optimized scoop 50 to enclose the panel 78. Thus, it will be appreciated by those skilled in the art that water or some other cooling fluid may be pumped through the cooling channels 68 and 70 inside the optimized scoop 50 to prevent the molten glass gobs from overheating it.

The optimized scoop 50 may be machined in a single piece (with the exception of the panels 76 and 78) of aluminum, stainless steel, or titanium. While stainless steel and titanium may be used without a coating, aluminum requires a plasma spray coating of a commercially available ceramic material such as those available from Praxair Surface Technologies, Inc. to prevent the glass gobs from sticking to the aluminum surface. Titanium has essentially the same characteristics as stainless steel, but also features significantly reduced weight.

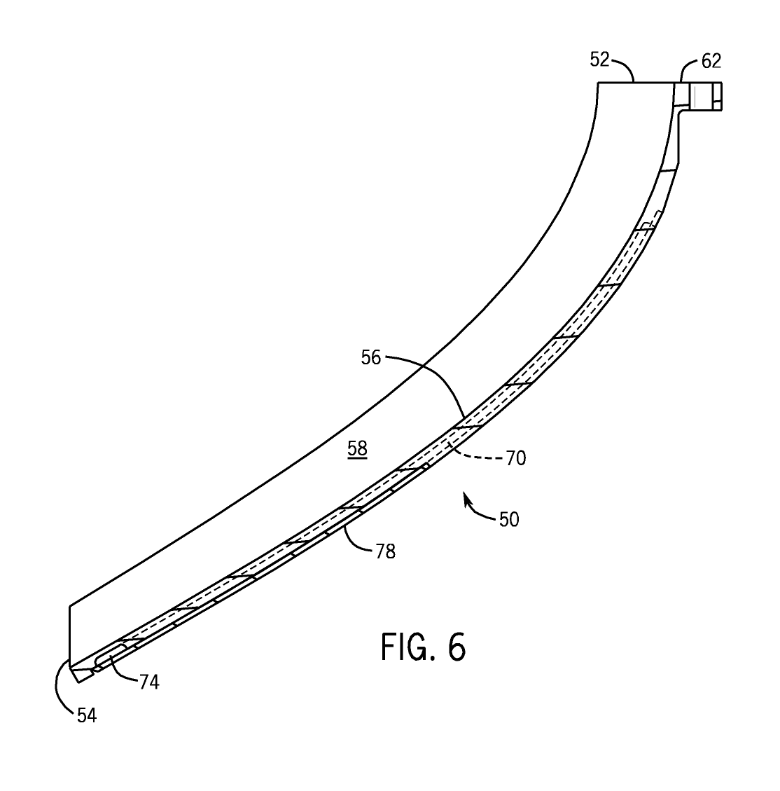

Referring now principally to FIGS. 3 and 6, in a preferred embodiment, the width of the semicircular bottom of the U-shape varies linearly along the curved portion 56 of the optimized scoop 50, from the maximum width at the upper end 52 of the optimized scoop 50 to the minimum width at the lower end 54 of the optimized scoop 50. The width at the lower end 54 of the optimized scoop 50 is selected to be smaller than the largest diameter of the glass gobs at the enlarged lower portion 40 of the glass gob 20 (shown in FIG. 2) and the enlarged upper portion 42 of the glass gob 20 (shown in FIG. 2) so that the optimized scoop 50 will act to shape glass gobs passing therethrough.

For example, for a glass gob having the enlarged lower portion 40 of the glass gob 20 (shown in FIG. 2) and the enlarged upper portion 42 of the glass gob 20 (shown in FIG. 2) both having diameters of approximately 32 millimeters, and the narrowed intermediate portion 44 of the glass gob 20 (shown in FIG. 2) having a diameter of approximately 30 millimeters, the width at the lower end 54 of the optimized scoop 50 is selected to approximately the same size as the diameters of the narrowed intermediate portion 44 of the glass gob 20, or approximately 30 millimeters. For this example, the width at the upper end 52 of the optimized scoop 50 may be approximately 46.5 millimeters.

While those skilled in the art will recognize that these dimensions may be varied considerably without departing from the spirit of the present invention, it is important that the width of the lower end 54 of the optimized scoop 50 must be slightly smaller than the width of at least one of the enlarged lower portion 40 of the glass gob 20 and the enlarged upper portion 42 of the glass gob 20 in order to extrude the glass gobs to more cylindrical configurations without greatly lengthening them. Optimally, the tapering in the optimized scoop 50 and the width of the lower end 54 of the optimized scoop 50 should be selected to optimize the shape of glass gobs passing through the optimized scoop 50 without either unduly lengthening them or significantly reducing the transit speed of glass gobs through the optimized scoop 50. Typically, the glass gobs may be lengthened as much as approximately twenty percent without incurring any significant disadvantage through so doing.

It will be recognized by those skilled in the art that while obtaining an improved glass gob shape through the use of a tapering cross-section in the curved portion 56 of the optimized scoop 50 is highly beneficial, it necessarily will result in at least some degree of slowing of the glass gobs as they pass through the optimized scoop 50. Thus, it is both desirable and beneficial to provide an optimized curvature to the curved portion 56 of the optimized scoop 50 between the upper end 52 of the optimized scoop 50 and the lower end 54 of the optimized scoop in order to obtain the highest possible transit speed of the glass gobs as they exit the optimized scoop 50. This curvature of the curved portion 56 of the optimized scoop 50 must be smooth and avoid discontinuities and reversals in curvature.

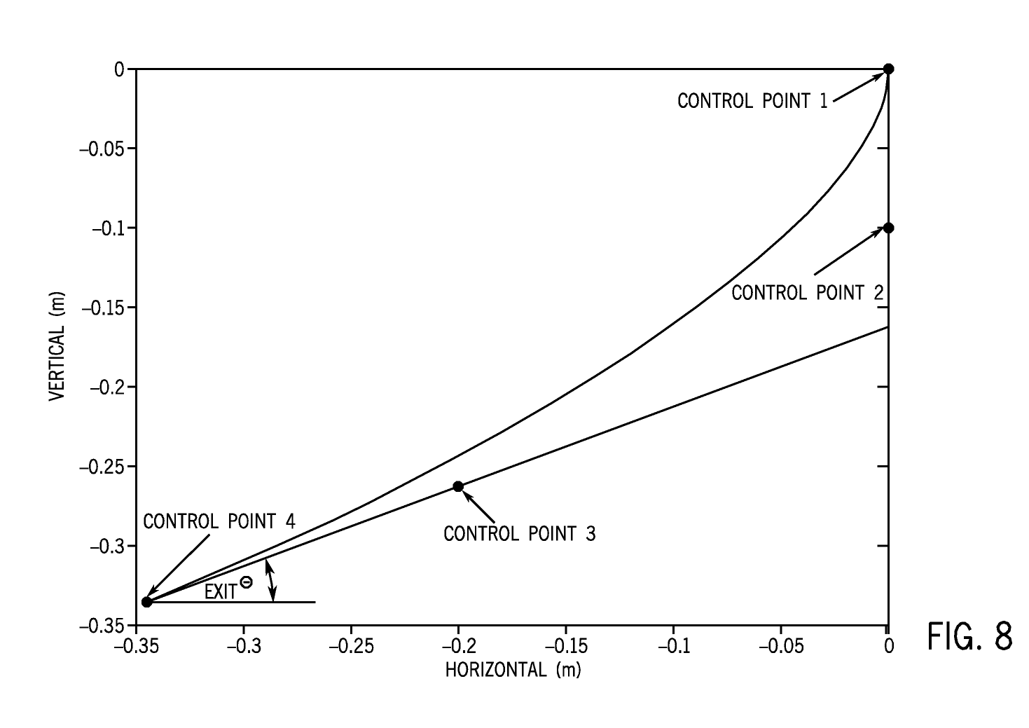

It has been discovered that an advantageous way of facilitating such an optimized curve in the curved portion 56 of the optimized scoop 50 between the upper end 52 of the optimized scoop 50 and the lower end 54 of the optimized scoop 50 is through the use of Bezier curves. In the approach used by the optimized scoop 50 of the present invention, Bezier curves are used to represent the trajectory of the optimized scoop 50, as shown in FIG. 8. Specifically, four control points (each with two coordinates for a total of eight adjustable parameters) are used to generate the curvature of the optimized scoop 50 which defines the trajectory of glass gobs passing therethrough. Two of these control points (Control Point 1 and Control Point 4) are the starting point and the end point of the optimized scoop 50, respectively, which are fixed (to thereby reduce the number of adjustable parameters to eight, two coordinates for each of the two remaining control points). The other two control points (Control Point 2 and Control Point 3) may be varied to change the overall shape of the curvature of the optimized scoop 50.

Since the glass gobs enter the optimized scoop 50 falling vertically due to gravity, Control Point 2 is along the vertical axis below Control Point 1. Since the trajectory at which glass gobs leave the optimized scoop 50 (for the trough 32 shown in FIG. 1) is defined by an acute angle • measured with respect to the horizontal axis, Control Point 3 will be along a line displaced at the acute angle • from the horizontal axis. By limiting the locations of Control Point 2 and Control Point 3 to their respective axes, the adjustability of the control points is limited to two parameters. By varying the relative positions of Control Point 2 and Control Point 3 on their respective axes, the overall shape of the curvature or trajectory of the optimized scoop 50 may be varied. The curve is given by the formula:

p(z)=(1−z)³c₄+3(1−z)²zc₃+3(1−z)z²c₂+z³c₁ with 0≦z≦1

The resulting trajectory is always tangent to the line extending between Control Point 1 and Control Point 2 at Control Point 1, and is always tangent to the line extending between Control Point 4 and Control Point 3 at Control Point 4. As the length of the line from Control Point 1 to Control Point 2 is increased, the trajectory will tend to maintain its initial slope and “stick” to the line from Control Point 1 to Control Point 2 longer. Similarly, as the length of the line from Control Point 4 to Control Point 3 is increased, the trajectory will tend to become approximately tangent to the line from Control Point 4 to Control Point 3 sooner, “sticking” to the line from Control Point 4 to Control Point 3 sooner.

By appropriately limiting the allowable selection of Control Point 2 and Control Point 3, the curve connecting Control Point 1 and Control Point 4 can be made to be well behaved. Specifically, the amount that Control Point 2 and Control Point 3 can move is limited by not allowing them to move beyond points where the curvature changes sign. If Control Point 2 is kept above the intersection of its vertical axis and the line including Control Point 4 and Control Point 3 that defines the exit angle, the curvature will not change sign. If Control Point 3 is not allowed to move to the right of the intersection of the line including Control Point 4 and Control Point 3 that defines the exit angle and the vertical axis below Control Point 1, the curvature will not change sign.

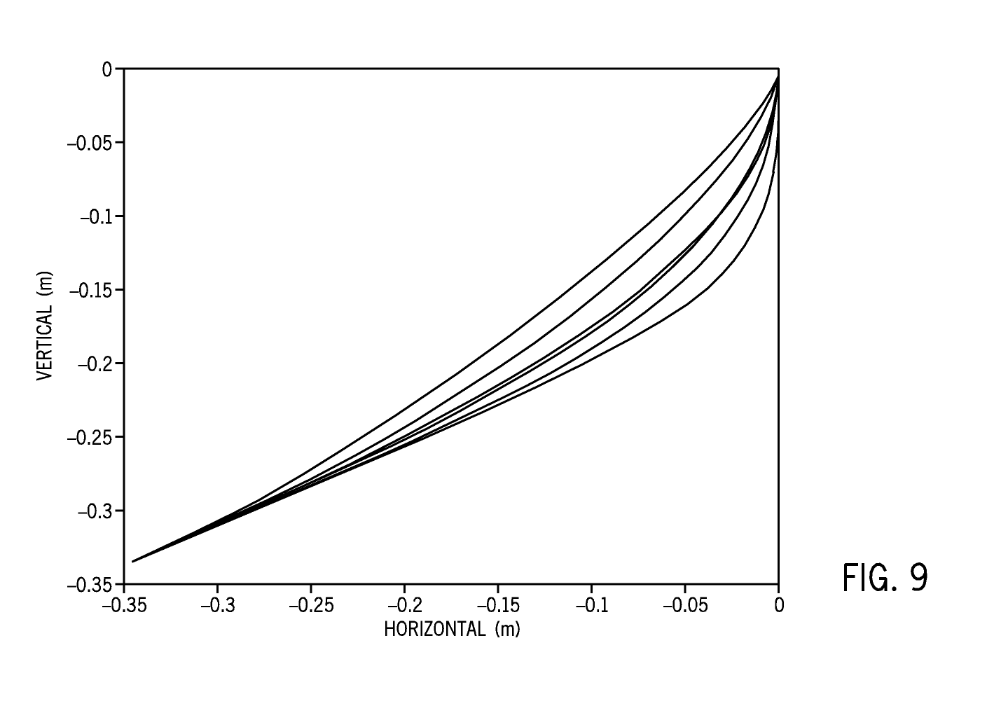

Referring now to FIG. 9, six exemplary potential trajectories for the optimized scoop 50 are illustrated. The optimum trajectory for the optimized scoop 50 is one that optimizes the exit velocity of glass gobs from the optimized scoop 50 while maintaining elongation of the glass gobs within an acceptable range. By performing a mathematical analysis referred to as computational fluid dynamics on each of these trajectory profiles, the effects the each of these different trajectory profiles have on glass gob exit velocity and glass gob elongation may be determined. Several different trajectory profiles may have glass gob exit velocities that are quite similar and other ways of identifying an optimal trajectory profile may be pursued.

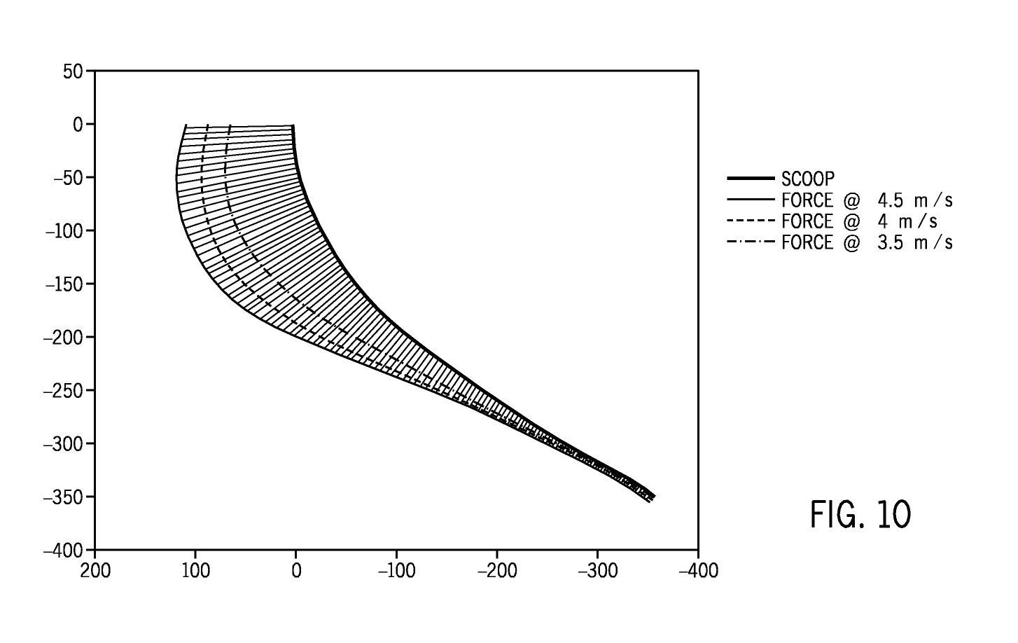

One such alternative manner of identifying an optimal trajectory profile is the use of normal force analysis, an example of which is illustrated in FIG. 10. This analysis determines the normal load on a glass gob entering the scoop at a predetermined velocity. The goal is to ensure a smooth and consistent normal force pattern and minimized peak normal load applied on glass gobs passing through the optimized scoop 50, while maintaining a smooth increase and decrease in the normal force. With gradual increases and decreases in the normal force, the curvature of the optimized scoop 50 should have less of an impact on glass gob shape. With a minimized normal force, less friction should be expected between the glass gobs and the optimized scoop 50, which means a minimal influence on glass gob deformation, speed, and elongation.

FIG. 10 shows a trajectory profile of the optimized scoop 50, with three curves depicting the normal force as given points on the optimized scoop 50 for three different initial glass gob velocities (as the glass gob enters the optimized scoop 50). The centripetal force is calculated by the following equation, where m is the mass of the glass gob, v is the velocity of the glass gob, and r is the radius of curvature of the optimized scoop 50 at the particular point:

$$F = \frac{m * {v}^{2}}{r}$$

As the glass gob goes around the curvature of the optimized scoop 50, the centripetal force increases, which leads to elongation of the glass gob. (This is why glass gob elongation is only seen on scoops and deflectors, not on troughs, since it is the centripetal force on the glass gob that causes it to elongate.) By applying this normal force analysis approach, a trajectory profile chosen based upon a computational fluid dynamics result may be verified. An optimum trajectory for the optimized scoop 50 will have a smooth increase in the centripetal force, while reducing the maximum normal force to which the glass gob will be subjected to an acceptable level. The optimum trajectory for the optimized scoop 50 generated by employing Bezier curve generation and this normal force analysis approach has been determined to present congruency with the computational fluid dynamics analysis. The optimized scoop 50 presents impressive results when compared to previously known scoops: no significant loss of velocity (and possibly a slight increase in velocity), a substantially improved glass gob shape, and a negligible increase in glass gob length.

It may therefore be appreciated from the above detailed description of the preferred embodiment of the present invention that it teaches an optimized scoop that improves glass gob shape as the glass gobs transit the optimized scoop. The improvements in glass gob shape are accomplished in the optimized scoop without any significant decrease in the speed of the glass gobs in the glass gob delivery system. The improvements in glass gob shape in the optimized scoop thus enhance glass gob shape to produce a more uniformly cylindrical glass gobs and eliminate the dog-bone shape while maintaining a sufficient exit velocity from the optimized scoop. Further, the improvement in glass gob shape is accomplished in the optimized scoop without significantly lengthening the glass gobs.

The optimized scoop of the present invention is of a construction which is both durable and long lasting, and which will require little or no maintenance to be provided by the user throughout its operating lifetime. The optimized scoop of the present invention is also of inexpensive construction to enhance its market appeal and to thereby afford it the broadest possible market. Finally, all of the aforesaid advantages and objectives of the optimized scoop of the present invention are achieved without incurring any substantial relative disadvantage.

Although the foregoing description of the optimized scoop of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A scoop for conveying gobs of molten glass falling vertically under the influence of gravity into said scoop to an ensuing gob delivery apparatus that receives gobs from said scoop at an angular trajectory for delivery by the ensuing gob delivery apparatus to a parison mold, said scoop comprising:
an inlet end of said scoop into which the gobs fall vertically under the influence of gravity;
an outlet end of said scoop from which the gobs are directed at an angular trajectory for delivery to the ensuing gob delivery apparatus; and
a curved portion of said scoop located between said inlet end of said scoop and said outlet end of said scoop;
wherein said scoop has a cross-sectional configuration that is generally concave and has a first width at said inlet end of said scoop and a second width at said outlet end of said scoop, said second width being smaller than the largest diameter portion of gobs entering said inlet end of said scoop.

2. A scoop as defined in claim 1, wherein said curved portion of said scoop is configured to modify the trajectory of gobs such that they will exit the scoop at the outlet end thereof at an acute angle with respect to the horizontal.

3. A scoop as defined in claim 2, wherein said acute angle is approximately thirty degrees.

4. A scoop as defined in claim 1, wherein said scoop has a cross-sectional configuration that is generally U-shaped.

5. A scoop as defined in claim 4, wherein said U-shaped cross-sectional configuration of said scoop has a semi-circular bottom and opposite sides above the semi-circular bottom that are approximately parallel.

6. A scoop as defined in claim 4, wherein the U-shaped cross-sectional configuration of said scoop has a width that tapers along said curved portion of said scoop from said inlet end of said scoop to said outlet end of said scoop.

7. A scoop as defined in claim 6, wherein the U-shaped cross-sectional configuration of said scoop has a tapered width along said curved portion of said scoop that is selected to optimize the shape of gobs passing through said scoop without either unduly lengthening the gobs or significantly reducing the transit speed of gobs as they pass through said scoop.

8. A scoop as defined in claim 6, wherein the U-shaped cross-sectional configuration of said scoop has a width that tapers linearly along said curved portion of said scoop from said inlet end of said scoop to said outlet end of said scoop.

9. A scoop as defined in claim 1, wherein the gobs have a “dog-bone” configuration as they fall vertically into said inlet end of said scoop, the gobs having larger diameters near top and bottom ends thereof and a smaller diameter at an intermediate portion thereof, wherein said second width is smaller than at least one of the larger diameters of the glass gobs near the top and bottom ends thereof.

10. A scoop as defined in claim 1, additionally comprising:
a mounting flange located at said inlet end of said scoop, said mounting flange being configured to support said scoop in position in a glass gob delivery system.

11. A scoop as defined in claim 1, additionally comprising:
a cooling channel located inside said scoop to provide cooling by circulating a cooling fluid through said cooling channel.

12. A scoop as defined in claim 1, wherein said scoop is made of a material selected from the group consisting of aluminum, stainless steel, and titanium.

13. A scoop as defined in claim 1, wherein the curvature of said curved portion of said scoop is smooth and avoids discontinuities and reversals in curvature in order to obtain the highest possible transit speed of gobs as they pass through said scoop.

14. A scoop as defined in claim 1, wherein the curvature of said curved portion of said scoop is defined by a Bezier curve.

15. A scoop as defined in claim 14, wherein said Bezier curve is optimized to maximize the exit velocity of gobs from said outlet end of said scoop while maintaining elongation of the gobs within an acceptable range.

16. A scoop as defined in claim 14, wherein said Bezier curve is optimized through the use of normal force analysis to ensure a smooth and consistent normal force pattern and minimized peak normal load applied to gobs passing through said scoop, while maintaining a smooth increase and decrease in the normal force.

17. A scoop as defined in claim 14, wherein said Bezier curve has respective end points c₁ and c₂ and respective control points c₃ and c₄, and wherein a curve defining said curved portion of said scoop is defined by the formula:
p(z)=(1−z)³c₄+3(1−z)²zc₃+3(1−z)z²c₂+z³c₁ with 0≦z≦1.

18. A scoop for conveying gobs of molten glass from an inlet end of said scoop into which the gobs fall vertically under the influence of gravity to an outlet end of said scoop from which the gobs are directed at an angular trajectory for delivery to an ensuing gob delivery apparatus that delivers the gobs to a parison mold, said scoop comprising:
an inlet end of said scoop into which the gobs fall vertically under the influence of gravity;
an outlet end of said scoop from which the gobs are directed at an angular trajectory for delivery to the ensuing gob delivery apparatus; and
a curved portion of said scoop located between said inlet end of said scoop and said outlet end of said scoop, wherein the curvature of said curved portion of said scoop is defined by a Bezier curve;
wherein said scoop has a cross-sectional configuration that is generally U-shaped and has a first width at said inlet end of said scoop which linearly tapers to a second width at said outlet end of said scoop, said second width being smaller than the largest diameter portion of gobs entering said inlet end of said scoop.

19. A scoop for conveying gobs of molten glass falling vertically under the influence of gravity an ensuing gob delivery apparatus that delivers the gobs to a parison mold, said scoop comprising:
an inlet end into which the gobs fall vertically under the influence of gravity;
an outlet end from which the gobs are directed at an angular trajectory for delivery to the ensuing gob delivery apparatus; and
a curved portion located between said inlet end and said outlet end;
wherein said scoop is configured to shape gobs into a more cylindrical shape.

20. A method for conveying gobs of molten glass falling vertically under the influence of gravity into a scoop to an ensuing gob delivery apparatus that receives gobs from the scoop at an angular trajectory for delivery by the ensuing gob delivery apparatus to a parison mold, said method comprising:
feeding the gobs so that they fall vertically under the influence of gravity into an inlet end of the scoop;
guiding the gobs through a curved portion of the scoop located between the inlet end of the scoop and an outlet end of the scoop, the scoop having a cross-sectional configuration that is generally U-shaped and has a first width at the inlet end of the scoop and a second width at the outlet end of the scoop, the second width being smaller than the largest diameter portion of gobs entering the inlet end of the scoop; and
directing the gobs from the outlet end of the scoop at an angular trajectory to the ensuing gob delivery apparatus.
